(19) United States
(12) Patent Application Publication
(10) Pub. No.: US 2004/0215781 A1
(43) Pub. Date: Oct. 28, 2004

(54) Techniques for determining device connectivity in a network using protocol-specific connectivity information

(76) Inventors: Eric A. Pulsipher, Ft. Collins, CO (US); Srikanth Natarajan, Ft. Collins, CO (US); Max Carl Knees, Ft. Collins, CO (US)

Correspondence Address: HEWLETT-PACKARD COMPANY, Intellectual Property Administration, P. O. Box 272400, Fort Collins, CO, 80527-2400, US

(21) Appl. No.: 10/397,676

(22) Filed: Mar. 27, 2003

(51) Int. Cl. G06F 15/16

(52) U.S. Cl. 709/227

(57) ABSTRACT

Techniques are described for determining device connectivity in a network using protocol-specific connectivity information. According to an exemplary embodiment, an address forwarding database (FDB) is collected from the network. Protocol-specific connectivity information and interface information are collected from a device in the network. The protocol-specific connectivity information and interface information are translated into an interface connectivity database. Device connectivity in the network is determined based on the interface connectivity database in cooperation with the FDB.

### BACKGROUND

Network management products, such as Hewlett Packard's Network Node Manager (HP's NNM), and NNM Extended Topology products, aid operators in managing large enterprise networks. These products use graphical topology maps to present management information and network topologies to operators. NNM and other network management products initially perform a discovery process that automatically discovers each device on a network. The discovery process can uncover information related to each network device, e.g., by examining the device's Management Information Base (MIB), and the connective relationship between the device and other devices discovered on the network.

During discovery, network management products use background processes to poll devices for connectivity information using standard protocols, such as Simple Network Management Protocol (SNMP) and Internet Control Message Protocol (ICMP). For example, NNM uses a combination of SNMP requests and ICMP pings to discover Internet Protocol (IP) devices operating on a network. IP devices intercommunicate at Layer 3 (or the Network Layer) of the Open Systems Interconnect (OSI) reference model using an IP or network address.

Not all devices in a network are interconnected via IP, however. For example, many devices intercommunicate at Layer 2 (or the Data Link Layer) using a media access control (MAC) address. MAC addresses are also referred to as physical addresses, and are associated with a particular network device. Certain types of network devices that operate at Layer 2, e.g., switches and bridges, keep records of the MAC addresses included in the packets of information they process. For example, a switch maintains a database of all MAC addresses received on all of its ports called a forwarding database, or FDB. The switch can use the information in the FDB to decide whether a frame should be forwarded or filtered. A typical FDB table can hold up to 128K entries. Each entry can include the MAC address of the device sending the packet, an identifier for the port on which the MAC address was received, and an identifier for the portion of the network (e.g., the Virtual Local Area Network or VLAN) to which the device belongs.

Network management products, such as NNM, can use FDBs to discover and map Layer 2 devices operating in a network. While the FDB information can be useful, it can also be misleading in that MAC addresses from devices not directly connected to a switch port (e.g., from devices several hops away) can be included in the FDB table. Without having additional information to eliminate these so-called “virtual connected” MAC addresses from the discovery database, devices may be incorrectly identified as being directly connected to a particular switch port when, in fact, they are located several hops away. SNMP can be used to improve the accuracy of topology maps by examining a device's MIB (devices that support bridge, repeater, and MAU MIBs) to discover Layer 2 devices, but not all devices support these MIBs.

Device manufacturers have developed proprietary protocols to perform network management functions in addition to the standard protocols, such as SNMP. “Proprietary protocols”, as used herein, can include protocols developed to function with particular manufacturers' equipment, and that may not function with other manufacturers' products. For example, Cisco Systems, Inc., has developed the Cisco Discovery Protocol (CDP) that is a media and protocol independent protocol that runs on all Cisco-manufactured equipment including routers, bridges, access and communication servers, and switches. CDP allows network management applications to discover Cisco devices that are neighbors of already known devices, in particular, neighbors running lower-layer, transparent protocols. While other manufacturers' devices, including certain HP-manufactured devices, do support CDP, not all devices can be discovered using CDP alone. The same can be said for other proprietary network management protocols.

Nevertheless, protocol-specific network connectivity information, such as that which can be obtained via CDP, can be helpful in improving the accuracy of discovery data. Because the protocol-specific connectivity information can be obtained via a proprietary protocol developed by manufacturers having detailed knowledge of their own network equipment, the connectivity information tends to be highly accurate.

### SUMMARY

In representative embodiments, techniques are described for determining device connectivity in a network using protocol-specific connectivity information. According to an exemplary embodiment, an address forwarding database (FDB) is collected from the network. Protocol-specific connectivity information and interface information are collected from a device in the network. The protocol-specific connectivity information and interface information are translated into an interface connectivity database. Device connectivity in the network is determined based on the interface connectivity database in cooperation with the FDB.

### BRIEF DESCRIPTION OF THE DRAWINGS

The accompanying drawings provide visual representations which will be used to more fully describe the representative embodiments disclosed herein and can be used by those skilled in the art to better understand them and their inherent advantages. In these drawings, like reference numerals identify corresponding elements, and:

FIG. 1 is a flowchart illustrating steps for determining device connectivity in a network using protocol-specific connectivity information according to an exemplary embodiment;

FIG. 2 illustrates a physical topology of an exemplary network;

FIG. 3 illustrates a protocol-specific discovered topology of the exemplary network depicted in FIG. 2;

FIG. 4 illustrates another discovered topology of the exemplary network depicted in FIG. 2; and

FIG. 5 illustrates a system for determining device connectivity in a network using protocol-specific connectivity information according to an exemplary embodiment.

### DETAILED DESCRIPTION

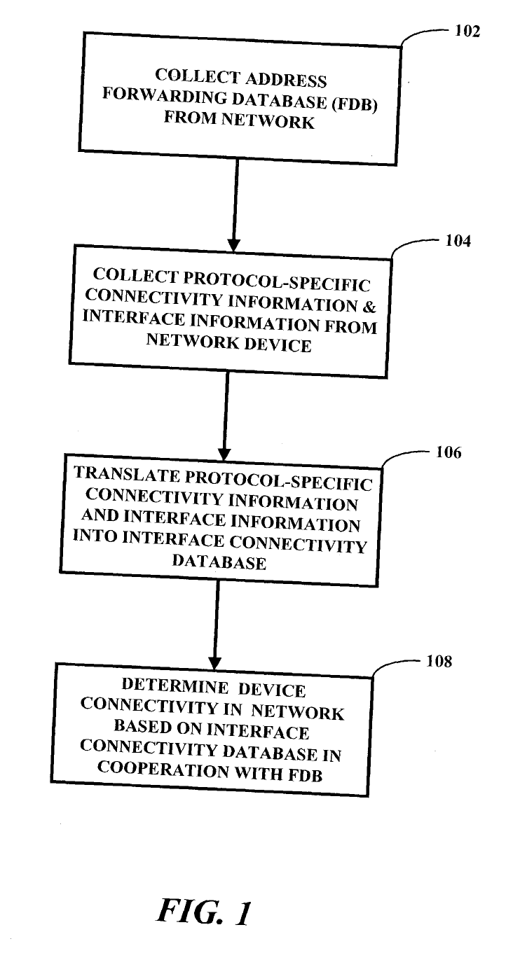

FIG. 1 is a flowchart illustrating the steps for displaying event information correlated with a performance parameter of the managed system. In step 102, an address forwarding database (FDB) is collected from the network. Various network management agents (e.g., processes that perform network management functions) can be invoked on devices located throughout the network to perform the data collection. These agents can include SNMP and other standard protocol-based agents used by network management products, such as NNM.

As described above, an FDB can be a forwarding database, maintained by a switch or bridge, of all MAC addresses received on all of its ports. The switch or bridge can use the information in the FDB to decide whether a frame should be forwarded or filtered. A typical FDB table can hold up to 128K entries. Each entry can include the MAC address of the device sending the packet, an identifier for the port on which the MAC address was received, and an identifier for the portion of the network (e.g., the Virtual Local Area Network or VLAN) to which the device belongs. Those skilled in the art will understand that an FDB can be any database maintained in the network that keeps track of the relationship between the interface ports of a particular device and identifiers (e.g., physical address, network address, hostname, etc.) of devices included in information that the particular devices forwards (e.g., routes, switches, etc.) to other devices in the network.

In step 104, protocol-specific connectivity information and interface information are collected from a device in the network. As described above, the protocol-specific connectivity information can be connectivity information obtained from a particular device using a proprietary protocol developed specifically for the particular device. For example, CDP is a media and protocol independent protocol developed by Cisco Systems, Inc., that runs on all Cisco-manufactured equipment including routers, bridges, access and communication servers, and switches. CDP allows network operators to view information about all Cisco devices directly attached to a CDP-capable device, e.g., a Cisco switch.

Network management applications can retrieve the device type and SNMP-agent address of neighboring Cisco devices using CDP. This enables applications to send SNMP queries to neighboring devices. CDP allows network management applications to discover Cisco devices that are neighbors of already known devices, in particular, neighbors running lower-layer, transparent protocols. The neighbor information available via CDP is summarized in Table 1.

A CDP agent (e.g., a process that performs CDP functions) can be invoked on the device (or perhaps on a remotely connected device) to collect the protocol-specific connectivity information from the device. The CDP agent can collect CDP data from the device, as well as MIB data (e.g., MIB-II SNMP data) stored in various MIBs included in the device. The MIB data can include information describing the various interface ports of the device, and is referred to herein as interface information. The following is an example of the protocol-specific connectivity information and interface information that can be collected from a CDP-capable device via a CDP agent:

```
UniqueAddress=‘15.2.121.109’;
Name=‘c8kloop.fc.hp.com’;
UpdAgent=‘CDP’;
LocalNbr={
    IfIndex=39;
    IfName=‘Pol’;
    IpAddress=‘15.2.144.1’;
    IfDescr=‘Port-channel1’;
    LocalNbrPhysAddr=‘00:D0:BA:25:CF:16’;
    };
RemoteNbr={
    RemoteNbrIpAddr=‘15.2.144.2’;
    IfName=‘3/5’;
    };
```

TABLE 1
CDP Neighbors Detail Field Descriptions

| Field | Definition |
|---|---|
| Device ID | The name of the neighbor device and either the MAC |
| | address or the serial number of this device. |
| Entry | A list of network addresses of neighbor devices. |
| address(es) | |
| [network | The network address of the neighbor device. The address |
| protocol] | can be in IP, IPX, AppleTalk, DECnet, or CLNS protocol |
| address | conventions. |
| Platform | The product name and number of the neighbor device. |
| Capabilities | The device type of the neighbor. This device can be a |
| | router, a bridge, a transparent bridge, a source-routing |
| | bridge, a switch, a host, an IGMP device, or a repeater. |
| Interface | The protocol and port number of the port on the current |
| | device. |
| Holdtime | The remaining amount of time, in seconds, the current |
| | device will hold the CDP advertisement from a transmitting |
| | router before discarding it. |
| Version | The software version of the neighbor device. |
| Duplex | The duplex state of connection between the current device |
| Mode | and the neighbor device. |
| Native | The ID number of the VLAN on the neighbor device. |
| VLAN | |
| VTP | A string that is the name of the collective group of VLANs |
| Management | associated with the neighbor device. |
| Domain | |

It will be understood by those skilled in the art that the CDP data collected by the CDP agent can also include interface information. Accordingly, the described demarcation between protocol-specific connectivity information and interface information in relation to what is described as CDP data and MIB data is not strict, and should not be limiting to what is described. Moreover, while the data available via CDP is described as an example of the protocol-specific connectivity information and interface information collected, persons skilled in the art will understand that protocol-specific connectivity information and interface information obtained via other proprietary protocols can be collected from a device in the network without departing from the scope of what is described herein.

At step 106, the protocol-specific connectivity information and interface information are translated into an interface connectivity database. If the protocol-specific connectivity information is inefficiently integrated with the connectivity information obtained via SNMP and FDBs, the overall accuracy of any resulting network topology map can be reduced. Inefficient integration of these different data sources can occur, e.g., if the information is considered sequentially in forming the topology map of the network. It can be advantageous to determine the device connectivity in the network based on a combination of the protocol-specific connectivity information and interface information and the FDB. Because the connectivity and interface information gathered by proprietary protocols is inherently organized into non-standard formats, it cannot be readily combined with the connectivity information gathered using “standard” protocols, e.g., SNMP, such as FDB and MIB information. Accordingly, the protocol-specific connectivity information and interface information are translated into an interface connectivity database that is more readily combinable with the FDB and MIB information.

According to exemplary embodiments, a database of pairs of connecting interfaces can be created from the collected protocol-specific connectivity information and interface information. Using the exemplary CDP data described above, a database can be created having an entry describing a pair of connecting interfaces as:

Name=‘c8kloop.fc.hp.com[0[39]]’;

NbrName=‘c55-sc0.fc.hp.com[0[270]]’;

where “c8kloop.fc.hp.com” is the name of the CDP-capable device having the UniqueAddress (e.g., IP address) of “15.2.121.109”, and “c55-sc0.fc.hp.com” is the name of a neighbor of the device having the IP address “15.2.144.2”. The name of the remote device “c55-sc0.fc.hp.com” can be included in the interface information collected by the CDP agent, or can be determined using Domain Name System (DNS) services. The entry can include other information such as the IfIndex of the interface, which is a unique numerical identifier for the interface port.

The translating of the protocol-specific connectivity information and interface information into the interface connectivity database can occur in any manner that enables the translated information to be more readily combinable with the FDB and MIB information. According to exemplary embodiments the database of pairs of connecting interfaces can be examined, and then a determination made as to whether at least one interface of a pair is included in a network switch. An entry can be added to the interface connectivity database, including interface information for the pair, if at least one interface of the pair is included in a network switch.

The entry added to the interface connectivity database can include a name identifier of the device. This name identifier can be a hostname of the device or any other identifier to distinguish the device from other devices that will be included in the network topology map. The entry can also include a network address identifier (an IP address) of the device. Information related to a local interface included in the pair associated with the device can also be included in the entry. The term “local interface” is used to describe an interface (or port) included in the device from which the connectivity information is being collected. Information related to a remote interface included in the pair can also be included in the entry. In contrast to a local interface, a “remote interface” is an interface associated with a neighboring device connected to the device.

A protocol-specific identifier can be included in the entry to identify the translated information. For example, the identifier “MergedDP”, meaning merged discovery protocol, can be included in each entry to indicate that the translated information represents the merging of protocol-specific and other discovery information. As such, the MergedDP data can be considered as being collected by a MergedDP pseudo-agent, similar to the data collected by SNMP, CDP, or other agents. In this way, the MergedDP data can be processed in cooperation with the FDB and/or MIB data collected by other agents by post-processing routines that create the network topology map.

Information related to the local interface can include a physical (e.g., MAC) address identifier of the local interface; a network (e.g., IP) address identifier of the local interface; and a name identifier (e.g., port/host name) of the local interface. Similarly, the information related to the remote interface can include a physical (e.g., MAC) address identifier of the remote interface; a network (e.g., IP) address identifier of the remote interface; and a name identifier (e.g., port/host name) of the remote interface. The following exemplary pseudo-code provides an example of how the protocol-specific connectivity information and interface information can be translated into an interface connectivity database, and an exemplary format of such a database.

```
//
// MergedDP.stch pseudocode
//
//
// Takes as inputs connectivity information created
// by protocol specific (e.g., CDP) agents and
// interface information derived from SNMP MIB-II requests
// to the network device. Provides output in the form
// of a table containing local interface to remote interface
// connectivity information.
//
MergedDP method {
    // allocate storage
    create database MergedDP;
    create table MergedDP.returns (
```

| | |
|---|---|
| Name text not null, | // text name of an |
| | entity |
| Unique Address text not null, | // IP address of an |
| | entity |

| | |
|---|---|
| Local Nbr object type neighbor, | // local entity interface |
| information | |
| RemoteNbr object type neighbor, | // remote entity interface |
| information | |
| UpdAgent text, | // “MergedDP” |
| ) | |

```
    // get the local and remote connection endpoints that layer stitcher
created
    select Name, NbrName from CDPLayer.entityByNeighbor
    // loop thru the collected endpoints
    foreach Name-NbrName pair {
        get the interface information for Name
        // Name=‘c8kloop.fc.hp.com[ 0 [ 39 ] ]’
        // BaseName=‘c8kloop.fc.hp.com’
        // UniqueAddress=‘15.2.121.109’
        // LocalNbr={
        // IfIndex=39
        // LocalNbrPhysAddr=‘00:D0:BA:25:CF:16’
        // LocalNbrIfType=6
        // IfDescr=‘Port-channel1’
        // IpAddress=‘15.2.144.1’
        // SubnetMask=‘255.255.255.248’
        // IfName=‘Pol’ }
        get the interface information for NbrName
        // Name=‘c55-sc0.fc.hp.com[ 0 [ 270 ] ]’
        // BaseName=‘c55-sc0.fc.hp.com’
        // UniqueAddress=‘15.2.144.2’
        // LocalNbr={
        // LocalNbrPhysAddr=‘00:10:7B:8B:60:34’
        // LocalNbrIfType=6
        // IfDescr=‘10/100 utp ethernet (cat 3/5)’
        // IfIndex=270
        // IfName=‘3/5’ }
        test that either Name or NbrName is a LAN switch
        // create an entry in the MergedDP.returns table
        insert into MergedDP.returns
            (
                Name,
                UniqueAddress,
                LocalNbr,
                RemoteNbr,
                UpdAgent
            )
        values
            (
                Name.BaseName,
                Name.UniqueAddress,
                Name.LocalNbr,
                {
                    NbrName.LocalNbrPhysAddr,
                    NbrName.UniqueAddress,
                    NbrName.BaseName
                },
                “MergedDP”
            ) ;”
        }
        cleanup and return
    }
```

In step 108, after translating the protocol-specific connectivity information and interface information into an interface connectivity database, device connectivity in the network can be determined based on the interface connectivity database in cooperation with the FDB. Considering the connectivity information provided by proprietary agents, such as the CDP agent described above, together with the collected FDB information, can produce network topology maps of greater detail and accuracy than the maps produced using techniques that consider only one of these data sources at a time. For example, according to exemplary embodiments, the determining of network connectivity using the interface connectivity database, together with the FDB, can include removing an interface connection based on the FDB from the device connectivity when a connection for the interface based on the interface connectivity database exists. This technique can avoid the problem of incorrectly identifying interfaces derived from the FDB as being shown to be directly connected to particular switch ports when, in fact, they are located several hops away from those switch ports.

According to exemplary embodiments, the FDB can be collected from a network switch having a number of interface ports. The FDB can include an entry for each physical (e.g., MAC) address received from a device on the interface ports. Each entry in the FDB can include an identifier of the interface port on which the corresponding physical address was received and an identifier of a portion of the network (e.g., the VLAN) to which the device belongs.

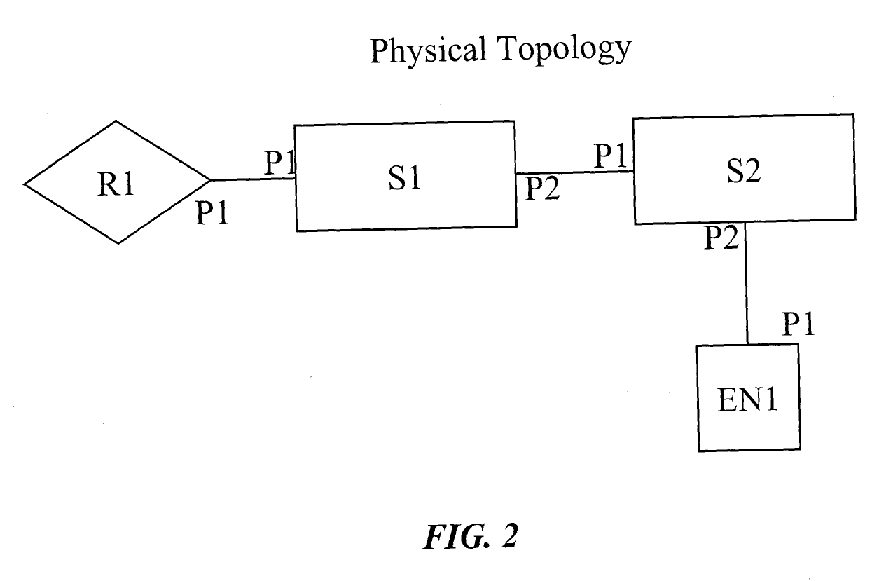

FIGS. 2-4 illustrate a simple example to provide a better understanding of the concepts described above. FIG. 2 shows the physical (i.e., actual) arrangement of four nodes in an exemplary network. The nodes are identified as R1 (router), S1 (switch), S2 (switch) and EN1 (personal computer or PC). In the example, information flows from the router R1, through the two switches S1, S2, to the PC EN1, and back again over the same path from the PC EN1 to the router R1. The nodes R1, S1 and S2 are all CDP-capable devices (i.e., they all are capable of using a common proprietary discovery protocol, e.g., CDP).

Table 2 represents a port-to-MAC relationship for the exemplary network shown in FIG. 2, where each port has a MAC addresses associated with it.

TABLE 2
MAC Address Table

| Node | Port | MAC |
|---|---|---|
| R1 | P1 | 00:00:00:00:00:01 |
| S1 | P1 | 00:00:00:00:00:02 |
| | P2 | 00:00:00:00:00:03 |
| S2 | P1 | 00:00:00:00:00:04 |
| | P2 | 00:00:00:00:00:05 |
| EN1 | P1 | 00:00:00:00:00:06 |

Table 3 shows exemplary FDB information collected from the switches S1, S2 that describes the relationship between the interface ports P1, P2 on each of the switches S1, S2 and the MAC addresses “heard”, or forwarded, on those ports. Note that neither switch S1, S2 “hears” its corresponding switch neighbor, even though the switches S1, S2 are directly connected to one another. This can occur because a switch typically will not replace MAC addresses included in outbound packets with its own port's MAC address. Unless the switches S1, S2 “ping” one another, there would be no reason for packets exchanged between the switches S1, S2 to contain the switch port MAC addresses. Accordingly, a network topology map generated using only the FDB information of table 3 (not shown) would not only fail to identify the direct connection between the switches S1, S2, but would also incorrectly identify the “virtual” connections between the switch S1 and PC EN1 and the switch S2 and router R1 as direct connections.

TABLE 3
FDB Information

| Node | Port | Hears MAC |
|---|---|---|
| S1 | P1 | 00:00:00:00:00:01 |
| | P2 | 00:00:00:00:00:06 |
| S2 | P1 | 00:00:00:00:00:01 |
| | P2 | 00:00:00:00:00:06 |

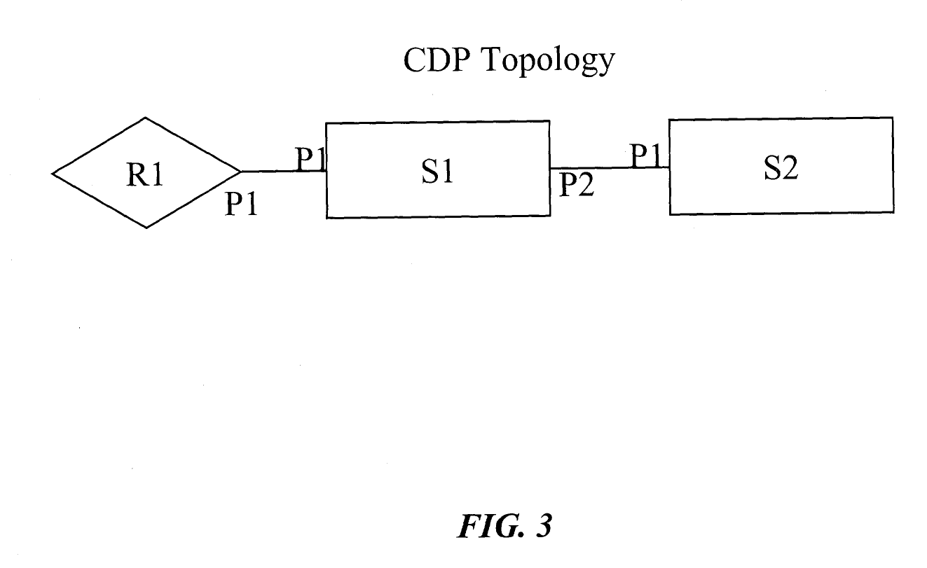

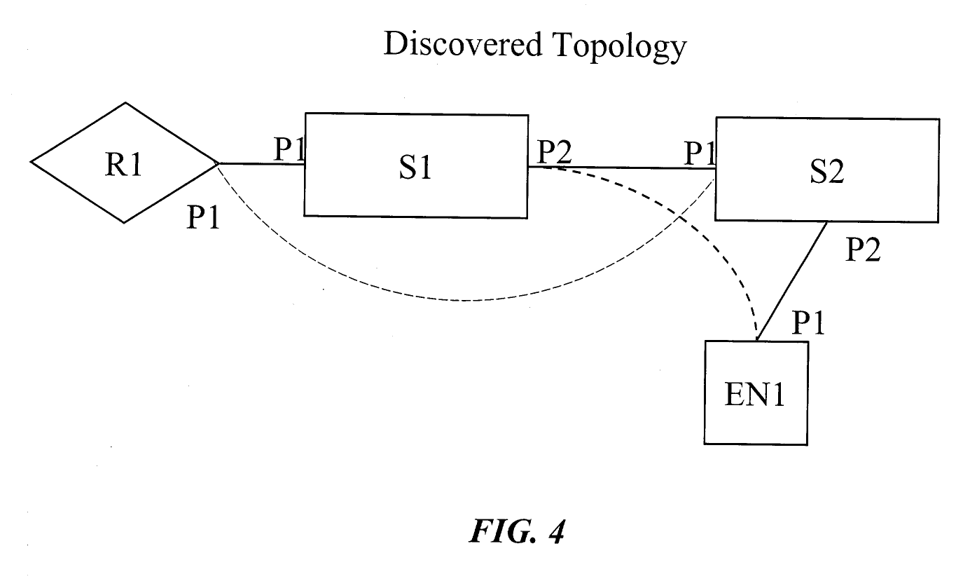

FIG. 3 shows an exemplary network topology map generated using only CDP. Note that the PC EN1 is absent from the topology map, as the PC EN1 does not support CDP. FIG. 4 shows an exemplary network topology map generated using CDP and FDB information separately, e.g., considering the information sequentially. Note that the incorrect “virtual” connections (indicated by dashed lines) derived from the FDB information shown in table 3 are present in the exemplary topology map.

TABLE 4
Connectivity Database Based on “MergedDP” and FDB Data

| Node | Port | Hears MAC |
|---|---|---|
| S1 | P1 | 00:00:00:00:00:01 |
| | P2 | 00:00:00:00:00:04 |
| | P2 | 00:00:00:00:00:06 (V) |
| S2 | P1 | 00:00:00:00:00:01 (V) |
| | P1 | 00:00:00:00:00:03 |
| | P2 | 00:00:00:00:00:06 |

Table 4 shows an exemplary connectivity database generated using the interface connectivity database (or “MergedDP” database) described herein, in cooperation with the FDB information shown in table 3. By using the additional CDP data incorporated into the “MergedDP” database, post-processing connectivity algorithms are able to map the connection between the switches S1, S2, and to mark the other addresses “heard” over the ports via FDB tables as virtual (V) connections instead of physical connections. As a result, the discovered topology coincides with the actual physical topology shown in FIG. 2.

Various aspects will now be described in connection with exemplary embodiments in terms of sequences of actions that can be performed by elements of a computer system. For example, it will be recognized that in each of the embodiments, the various actions can be performed by specialized circuits or circuitry (e.g., discrete logic gates interconnected to perform a specialized function), by program instructions being executed by one or more processors, or by a combination of both. Moreover, the exemplary embodiments can be considered part of any form of computer readable storage medium having stored therein an appropriate set of computer instructions that would cause a processor to carry out the techniques described herein.

Thus, the various aspects can be embodied in many different forms, and all such forms are contemplated to be within the scope of what is described. For each of the various aspects, any such form of embodiment can be referred to herein as “logic configured to” perform a described action, or alternatively as “logic that” performs or “logic capable of” performing a described action.

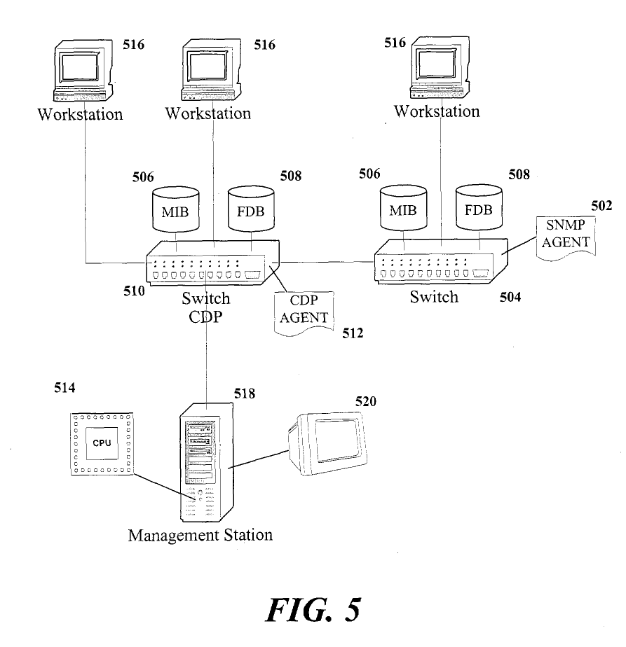

A system for determining device connectivity in a network using protocol-specific connectivity information according to an exemplary embodiment is shown in FIG. 5. The system includes means, such as a first agent including logic, for collecting an address forwarding database (FDB) from the network. The first agent can be an SNMP agent 502 operating on a device in the network, e.g., a switch 504. The first agent can use, e.g., SNMP requests, to collect MIB 506 and FDB 508 information maintained in various network components, e.g., the switches 504, 510. The system also includes means, such a second agent, e.g., a CDP agent 512, having logic, for collecting protocol-specific connectivity information, e.g., CDP data, and interface information, e.g., MIB-II data, from a device, e.g., the switch 510, in the network.

Means, such as a processor 514, is included in the system having logic capable of translating the protocol-specific connectivity information and interface information into an interface connectivity database. The processor 514 also includes logic capable of determining device connectivity in the network based on the interface connectivity database in cooperation with the FDB. The processor 514 can be included in a management station 518 that is capable of monitoring and collecting data from the devices that comprise a particular management domain, e.g., switches 504, 510 and workstations 516. The management station 518 can include management software, such as NNM, supported by the processor 514. The management software can be capable of performing queries, e.g., SNMP requests, to the network devices 504, 510, 516 for MIB data. The determined device connectivity can be presented on a display 520 (e.g., a management console operatively coupled to the management station 518) in the form of a network topology map.

It will be understood by those skilled in the art that the arrangement of components shown in FIG. 5 is merely illustrative and that these components can be arranged in other configurations without departing from the scope of what is described herein. For example, although only one CDP agent 512 is shown in the figure, typically all CDP-capable devices 510 in the network can include a CDP agent, although this need not be the case. The same holds true for the single SNMP agent 502 shown in the figure. Finally, as described above, typically only certain network devices, e.g., devices that support bridge, repeater, and MAU MIBs, include MIB data, and typically FDB information is maintained in Layer 2 switching devices, e.g., switches and bridges, but again this need not be the case.

The steps of a computer program, as illustrated in FIG. 1, for determining device connectivity in a network using protocol-specific connectivity information can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used herein, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described herein can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

What is claimed is:

1. A method for determining device connectivity in a network, the method comprising:
collecting an address forwarding database (FDB) from the network;
collecting protocol-specific connectivity information and interface information from a device in the network;
translating the protocol-specific connectivity information and interface information into an interface connectivity database; and
determining device connectivity in the network based on the interface connectivity database in cooperation with the FDB.

2. The method of claim 1, comprising:
creating a database of pairs of connecting interfaces from the protocol-specific connectivity information;

3. The method of claim 2, wherein the translating comprises:
examining the database of pairs of connecting interfaces;
determining if at least one interface of a pair is included in a network switch; and
adding an entry to the interface connectivity database including interface information for the pair if at least one interface of the pair is included in a network switch.

4. The method of claim 3, wherein the entry added to the interface connectivity database comprises:
a name identifier of the device;
a network address identifier of the device;
information related to a local interface included in the pair associated with the device;
information related to a remote interface included in the pair associated with a neighboring device connected to the device; and
a protocol-specific identifier.

5. The method of claim 4, wherein the information related to the local interface comprises:
a physical address identifier of the local interface;
a network address identifier of the local interface; and
a name identifier of the local interface.

6. The method of claim 4, wherein the information related to the remote interface comprises:
a physical address identifier of the remote interface;
a network address identifier of the remote interface; and
a name identifier of the remote interface.

7. The method of claim 1, wherein the determining comprises:
removing an interface connection based on the FDB from the device connectivity when a connection for the interface based on the interface connectivity database exists.

8. The method of claim 1, wherein the FDB is collected from a network switch having a number of interface ports.

9. The method of claim 8, wherein the FDB comprises an entry for each physical address received from a device on the interface ports, each entry including an identifier of the interface port on which the corresponding physical address was received and an identifier of a portion of the network to which the device belongs.

10. The method of claim 1, wherein the protocol-specific connectivity information and interface information is collected from the device via Cisco Discovery Protocol (CDP) and Simple Network Management Protocol (SNMP).

11. The method of claim 10, wherein the collected protocol-specific connectivity information and interface information comprises:
a physical address of a neighboring device connected to the device;
a network address of the neighboring device; and
a port identifier of an interface included in the device connected to the neighboring device.

12. A system for determining device connectivity in a network, the system comprising:
a first agent including logic for collecting an address forwarding database (FDB) from the network;
a second agent including logic for collecting protocol-specific connectivity information and interface information from a device in the network; and
a processor, including:
logic capable of translating the protocol-specific connectivity information and interface information into an interface connectivity database; and
logic capable of determining device connectivity in the network based on the interface connectivity database in cooperation with the FDB.

13. The system of claim 12, wherein the processor includes:
logic for creating a database of pairs of connecting interfaces from the protocol-specific connectivity information;

14. The system of claim 13, wherein the logic capable of translating comprises:
logic capable of examining the database of pairs of connecting interfaces;
logic capable of determining if at least one interface of a pair is included in a network switch; and
logic capable of adding an entry to the interface connectivity database including interface information for the pair if at least one interface of the pair is included in a network switch.

15. The system of claim 14, wherein the entry added to the interface connectivity database comprises:
a name identifier of the device;
a network address identifier of the device;
information related to a local interface included in the pair associated with the device;
information related to a remote interface included in the pair associated with a neighboring device connected to the device; and
a protocol-specific identifier.

16. The system of claim 15, wherein the information related to the local interface comprises:
a physical address identifier of the local interface;
a network address identifier of the local interface; and
a name identifier of the local interface.

17. The system of claim 15, wherein the information related to the remote interface comprises:
a physical address identifier of the remote interface;
a network address identifier of the remote interface; and
a name identifier of the remote interface.

18. The system of claim 12, wherein the logic capable of determining comprises:
logic capable of removing an interface connection based on the FDB from the device connectivity when a connection for the interface based on the interface connectivity database exists.

19. The system of claim 12, wherein the FDB is collected from a network switch having a number of interface ports.

20. The system of claim 19, wherein the FDB comprises an entry for each physical address received from a device on the interface ports, each entry including an identifier of the interface port on which the corresponding physical address was received and an identifier of a portion of the network to which the device belongs.

21. The system of claim 12, wherein the second agent is a Cisco Discovery Protocol (CDP) capable of collecting the protocol-specific connectivity information and interface information via CDP and Simple Network Management Protocol (SNMP).

22. The system of claim 21, wherein the collected protocol-specific connectivity information and interface information comprises:
a physical address of a neighboring device connected to the device;
a network address of the neighboring device; and
a port identifier of an interface included in the device connected to the neighboring device.

23. A computer readable medium containing a computer program for determining device connectivity in a network, wherein the computer program performs the steps of:
collecting an address forwarding database (FDB) from the network;
collecting protocol-specific connectivity information and interface information from a device in the network;
translating the protocol-specific connectivity information and interface information into an interface connectivity database; and
determining device connectivity in the network based on the interface connectivity database in cooperation with the FDB.

24. The computer readable medium of claim 23, wherein the computer program performs the step of:
creating a database of pairs of connecting interfaces from the protocol-specific connectivity information;

25. The computer readable medium of claim 24, wherein in translating, the computer program performs the steps of:
examining the database of pairs of connecting interfaces;
determining if at least one interface of a pair is included in a network switch; and
adding an entry to the interface connectivity database including interface information for the pair if at least one interface of the pair is included in a network switch.

26. The computer readable medium of claim 25, wherein the entry added to the interface connectivity database comprises:
a name identifier of the device;
a network address identifier of the device;
information related to a local interface included in the pair associated with the device;
information related to a remote interface included in the pair associated with a neighboring device connected to the device; and
a protocol-specific identifier.

27. The computer readable medium of claim 26, wherein the information related to the local interface comprises:
a physical address identifier of the local interface;
a network address identifier of the local interface; and
a name identifier of the local interface.

28. The computer readable medium of claim 26, wherein the information related to the remote interface comprises:
a physical address identifier of the remote interface;
a network address identifier of the remote interface; and
a name identifier of the remote interface.

29. The computer readable medium of claim 23, wherein in determining, the computer performs the steps of:
removing an interface connection based on the FDB from the device connectivity when a connection for the interface based on the interface connectivity database exists.

30. The computer readable medium of claim 23, wherein the FDB is collected from a network switch having a number of interface ports.

31. The computer readable medium of claim 30, wherein the FDB comprises an entry for each physical address received from a device on the interface ports, each entry including an identifier of the interface port on which the corresponding physical address was received and an identifier of a portion of the network to which the device belongs.

32. The computer readable medium of claim 23, wherein the computer collects the protocol-specific connectivity information and interface information via Cisco Discovery Protocol (CDP) and Simple Network Management Protocol (SNMP).

33. The computer readable medium of claim 32, wherein the collected protocol-specific connectivity information and interface information comprises:
a physical address of a neighboring device connected to the device;
a network address of the neighboring device; and
a port identifier of an interface included in the device connected to the neighboring device.

34. A system for determining device connectivity in a network, the system comprising:
means for collecting an address forwarding database (FDB) from the network;
means for collecting protocol-specific connectivity information and interface information from a device in the network;
means for translating the protocol-specific connectivity information and interface information into an interface connectivity database; and
means for determining device connectivity in the network based on the interface connectivity database in cooperation with the FDB.

35. The system of claim 34, comprising:
means for creating a database of pairs of connecting interfaces from the protocol-specific connectivity information;

36. The system of claim 35, wherein the means for translating comprises:
means for examining the database of pairs of connecting interfaces;
means for determining if at least one interface of a pair is included in a network switch; and
means for adding an entry to the interface connectivity database including interface information for the pair if at least one interface of the pair is included in a network switch.

37. The system of claim 36, wherein the entry added to the interface connectivity database comprises:
a name identifier of the device;
a network address identifier of the device;
information related to a local interface included in the pair associated with the device;
information related to a remote interface included in the pair associated with a neighboring device connected to the device; and
a protocol-specific identifier.

38. The system of claim 37, wherein the information related to the local interface comprises:
a physical address identifier of the local interface;
a network address identifier of the local interface; and
a name identifier of the local interface.

39. The system of claim 37, wherein the information related to the remote interface comprises:
a physical address identifier of the remote interface;
a network address identifier of the remote interface; and
a name identifier of the remote interface.

40. The system of claim 34, wherein the means for determining comprises:
means for removing an interface connection based on the FDB from the device connectivity when a connection for the interface based on the interface connectivity database exists.

41. The system of claim 34, wherein the FDB is collected from a network switch having a number of interface ports.

42. The system of claim 41, wherein the FDB comprises an entry for each physical address received from a device on the interface ports, each entry including an identifier of the interface port on which the corresponding physical address was received and an identifier of a portion of the network to which the device belongs.

43. The system of claim 34, wherein the protocol-specific connectivity information and interface information is collected from the device via Cisco Discovery Protocol (CDP) and Simple Network Management Protocol (SNMP).

44. The system of claim 43, wherein the collected protocol-specific connectivity information and interface information comprises:
a physical address of a neighboring device connected to the device;
a network address of the neighboring device; and
a port identifier of an interface included in the device connected to the neighboring device.
